(19) United States
(12) Patent Application Publication
(10) Pub. No.: US 2026/0164482 A1
(43) Pub. Date: Jun. 11, 2026

(54) NETWORK-ASSISTED ONBOARDING OF IoT DEVICES

(71) Applicant: Charter Communications Operating, LLC, St. Louis, MO (US)

(72) Inventors: Ryan William Loaiza, Brighton, CO (US); Taren Geddes McCullough, Plymouth, MN (US); Daniela Capoj, Englewood, CO (US)

(73) Assignee: Charter Communications Operating, LLC, St. Louis, MO (US)

(21) Appl. No.: 18/972,160

(22) Filed: Dec. 6, 2024

(51) Int. Cl. H04W 76/14; H04B 17/309; H04W 24/04; H04W 76/19; H04W 84/12

(52) U.S. Cl. CPC H04W 76/14; H04B 17/346; H04W 24/04; H04W 76/19; H04W 84/12

(57) ABSTRACT

In certain embodiments, an access point (AP) of a wireless, e.g., WiFi, network actively assists user equipment (UE) in the onboarding of an IoT device onto the network. The AP determines whether the UE is using AP mode or EZ mode onboarding. If EZ mode, then the AP determines whether bandsteering is needed and, if so, the AP actively tries to get the UE to switch to the 2.4 GHz band. If switching is not successful, then the AP may relay incoming IoT onboarding messages received from the UE in a non-2.4 GHz band as outgoing IoT onboarding messages in the 2.4 GHz band to attempt to associate the IoT device with the AP. Network-assisted onboarding can address problems that would otherwise result in failed onboarding such as when the user forgets to switch the UE to the 2.4 GHz band for EZ mode onboarding.

### BACKGROUND

### Field of the Disclosure

The present disclosure relates to IoT (Internet of Things) devices and, more specifically but not exclusively, to techniques for onboarding IoT devices onto wireless networks.

### Description of the Related Art

This section introduces aspects that may help facilitate a better understanding of the disclosure. Accordingly, the statements of this section are to be read in this light and are not to be understood as admissions about what is prior art or what is not prior art.

A typical IoT (Internet of Things) device is a device that is wirelessly connected to a wireless network, such as a WiFi network, and performs some function through cloud control. The onboarding (i.e., connecting) of an IoT device onto a WiFi network typically involves a user using a wireless device (AKA user equipment or UE for short), such as a cellphone or tablet, to wirelessly connect to an access point (AP) of the WiFi network and then run an associated IoT app on the UE to wirelessly connect the IoT device to that WiFi network.

There are two primary connection techniques for an IoT device: AP mode and EZ mode. In AP mode, the user uses their UE to connect the IoT device to the WiFi network manually or by scanning a QR code. In EZ mode, the IoT device typically communicates in the 2.4 GHz WiFi band and, if needed, the user must manually steer their UE to that 2.4 GHz band from, for example, the 5 GHz or 6 GHz WiFi band. In either mode, the AP of the WiFi network is a passive participant in the onboarding process relying on the user to properly navigate the selected connection mode.

In AP mode, the IoT device sets up its own WLAN and emulates an Access Point having its own SSID, which the UE uses to connect to the IoT device and, once connected, the UE shares with the IoT device the SSID and password for the user's private WiFi home network, which the IoT device then uses to connect to that WiFi network. In EZ Mode, the UE sends unicast traffic over the air containing the SSID and password for the user's private WiFi home network. The IoT device listens for this unicast traffic and, once decoded, uses the information to connect to the WiFi network.

There are a number of different mistakes that a user can make that will result in unsuccessful onboarding of an IoT device. For example, if the user fails to steer their UE to the 2.4 GHz band, then the EZ mode will fail to onboard the IoT device successfully.

### SUMMARY

Problems in the prior art are addressed in accordance with the principles of the present disclosure by a network-assisted technique in which a component of a wireless network, such as an access point of a WiFi network, determines the onboarding mode being used to attempt to onboard an IoT device, e.g., the AP or EZ mode for a WiFi network, and then actively assists in that onboarding process.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified block diagram illustrating a WiFi network having an access point, where a user's UE is operated in either AP mode or EZ mode to connect an IoT device to the AP in order to onboard the IoT device onto the WiFi network according to certain embodiments of network-assisted onboarding of the disclosure;

FIG. 2 is a flow diagram of the main flow of steps involved in onboarding the IoT device onto the WiFi network of FIG. 1 according to certain embodiments of network-assisted onboarding of the disclosure;

FIG. 3 is a flow diagram of the steps involved in the AP performing the Onboarding Method Detection processing of step 208 of FIG. 2; and

FIG. 4 is a flow diagram of the steps involved in the AP performing the Steering Method processing of step BL of FIG. 2.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

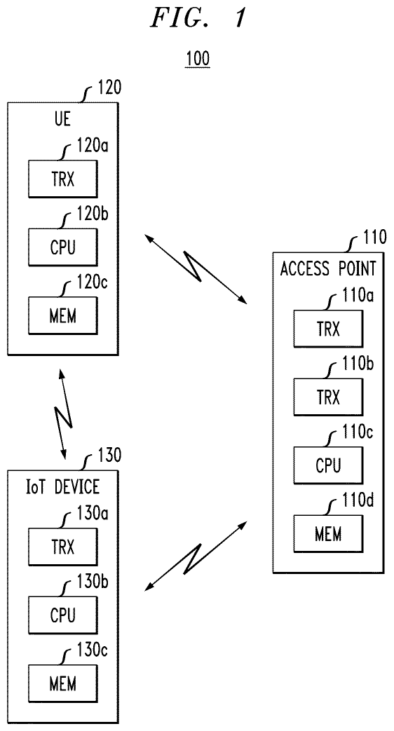

FIG. 1 is a simplified block diagram illustrating a WiFi network 100 having an access point 110, where a user's UE 120 is operated in either AP mode or EZ mode to connect an IoT device 130 to the AP 110 in order to onboard the IoT device onto the WiFi network 100 according to certain embodiments of network-assisted onboarding of the disclosure that involve an app running on a user's UE 120 that operates in either AP mode or EZ mode to connect the IoT device 130 to the AP 110.

Those skilled in the art will understand that there may be other wireless devices (not shown) within the coverage area of the AP 110 and that the AP 110 is connected to a backend communication system (not shown) that supports communication between the AP 110 and wireless devices within its coverage area as well as between the AP 110 and the outside world. In addition, although not shown in FIG. 1, the WiFi network 100 may have additional APs as well as other backend elements that support the functionality of the WiFi network 100 for communicating with multiple other wireless devices.

As shown in FIG. 1, the UE 120 includes (i) a wireless transceiver (TRX) 120a for transmitting wireless signals to and receiving wireless signals from the AP 110 and/or the IoT device 130 and (ii) one or more processors (e.g., CPU and/or GPU microprocessors) 120b for controlling the operations of the UE 120, including the processing of outgoing and incoming signals to and from the AP 110 and/or the IoT device 130 based on software code stored in the UE's memory (MEM) 120c. Similarly, the IoT device 130 includes (i) a wireless TRX 130a for transmitting wireless signals to and receiving wireless signals from the AP 110 and/or the UE 120 and (ii) one or more processors (e.g., CPU and/or GPU microprocessors) 130b for controlling the operations of the IoT device 130, including the processing of outgoing and incoming signals to and from the AP 110 and/or the UE 120 based on software code stored in the UE's memory 130c. Analogously, the AP 110 includes (i) a wireless transceiver 110a for transmitting and receiving wireless signals to and from the UE 120 and/or the IoT device 130, (ii) a backend transceiver 110b for transmitting and receiving (wired or wireless, depending on the implementation) signals to and from the backend communication system (not shown), and (iii) one or more processors 110c for controlling the operations of the AP 110, including the processing of outgoing and incoming signals to and from the UE 120 and/or the IoT device 130 and the backend communication system based on software code stored in the AP's memory 110d.

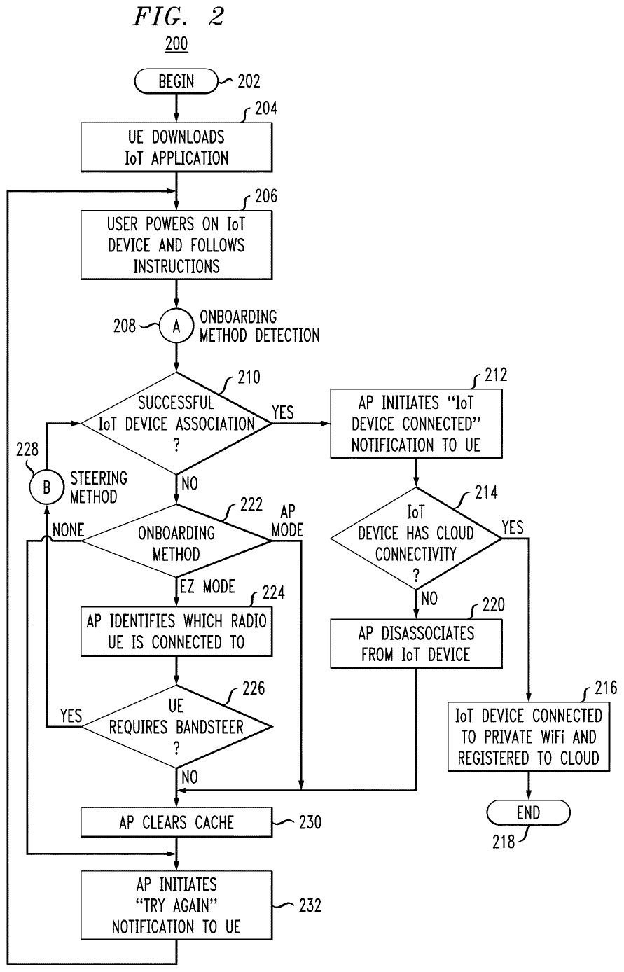

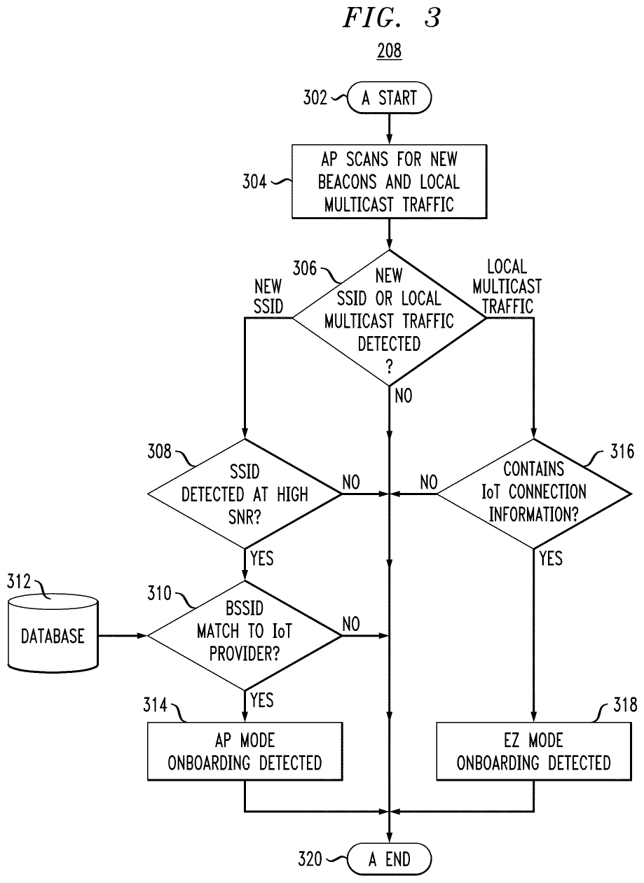

FIG. 2 is a flow diagram of the main flow 200 of steps 202-232 involved in onboarding the IoT device 130 onto the WiFi network 100 of FIG. 1 according to certain embodiments of network-assisted onboarding of the disclosure in which the AP 110 of FIG. 1 assists in the onboarding of the IoT device 130 onto the WiFi network 100 using an IoT app running on the UE 120. The main flow of FIG. 2 begins at step 202. In step 204, the user downloads the IoT app onto the UE, and, in step 206, the user powers on the IoT device and follows the IoT app instructions on the UE. In step 208, the AP performs the Onboarding Method Detection processing of FIG. 3 to try to determine whether the onboarding is being performed in the AP mode or the EZ mode.

FIG. 3 is a flow diagram of the steps 302-320 involved in the AP performing the Onboarding Method Detection processing of step 208 of FIG. 2 to try to determine if either the AP mode or the EZ mode has been detected.

Those skilled in the art will understand that the AP mode will typically result in the AP receiving from the UE a new beacon (i.e., a beacon having an SSID (Service Set Identifier) not recently received by the AP), where the new beacon has (i) sufficient signal strength (e.g., a signal-to-noise ratio (SNR) greater than a specified threshold value) and (ii) a BSSID (Basic SSID) corresponding to an IoT device provider (e.g., a known manufacturer or distributor of IoT devices). Those skilled in the art will also understand that the EZ mode will involve the AP receiving from the UE local multicast traffic containing IoT connection information.

In step 304, the AP scans for new beacons and local multicast traffic. If, in step 306, the AP fails to detect either a new beacon or local multicast traffic, then processing ends at step 320 without detecting either AP or EZ mode.

If the AP detects, in step 306, a new beacon, then processing proceeds to step 308, where the AP determines whether the beacon has a sufficiently high SNR. If not, then processing ends at step 320 without detecting either AP or EZ mode as before. Otherwise, the beacon has sufficiently high SNR and processing proceeds to step 310.

In step 310, the AP accesses a local database 312 to determine whether the beacon has a BSSID that corresponds to an IoT provider. If not, then processing ends at step 320 without detecting either AP or EZ mode as before. Otherwise, the beacon has a BSSID that corresponds to an IoT provider, and, in step 314, the AP determines that AP mode onboarding has been detected, and the processing of FIG. 3 then ends at step 320 with the AP mode having been detected.

If, in step 306, the AP detects local multicast traffic, then, in step 316, the AP determines whether that traffic contains IoT connection information. If not, then processing ends at step 320 without detecting either AP or EZ mode as before. Otherwise, the AP determines that the detected local multicast traffic does contain IoT connection information, and, in step 318, the AP determines that EZ mode onboarding has been detected, and the processing of FIG. 3 then ends at step 320 with the EZ mode having been detected.

Returning to FIG. 2, after trying to detect AP mode or EZ mode in step 208, in step 210, the AP determines whether the IoT device was successfully associated with the WiFi network. This is a part of the logic built into the AP. Once the IoT device is successfully associated, the IoT device will receive an IP address from the AP. The IoT device's MAC address will also be saved onto the AP and routing tables will be updated to include the IoT device. If the AP determines, in step 210, that the association was successful, then, in step 212, the AP notifies the UE that the IoT device is connected to the WiFi network. In step 214, the AP determines whether the IoT device is connected to the cloud. The AP can monitor packets to check if the IoT device is receiving packets down and sending packets up to the cloud. Alternatively, the user can manually press a button on their UE that tells the AP that the IoT device is not connected to the cloud. If so, then, in step 216, the AP determines that the IoT device is connected and registered to the cloud (i.e., successfully onboarded onto the WiFi network) and the onboarding processing of FIG. 2 ends at step 218.

If, in step 214, the AP determines that the connected IoT device is not connected to the cloud, then the onboarding of the IoT device has not been successful and processing proceeds to step 220, where the AP disassociates from the IoT device. This process involves the AP sending disassociation and deauthentication messages to the IoT device. Processing then continues to step 230, where the AP clears cache (e.g., deletes any counters associated with the IoT device, the IoT device's DHCP (Dynamic Host Configuration Protocol) reservation, and the instances where the AP has saved the MAC (Media Access Control) address of the IoT device). Processing then continues to step 232, where the AP instructs the UE to try to onboard the IoT device again at step 206.

Returning to step 210, if the AP determines that the IoT device was not successfully associated, then processing proceeds to step 222, where the AP determines whether an onboarding method was detected in step 208 and if so, whether AP mode or EZ mode was detected. If no onboarding method was detected in step 208, then processing proceeds from step 222 to step 232 as before. If step 222 determines that AP mode was detected in step 208, then the attempt at onboarding the IoT device using the AP mode was not successful and processing proceeds to step 230 as before. There are a few different scenarios where a user could make a mistake that could result in a failed attempt using the AP mode onboarding method. A subsequent attempt at onboarding could result in a success if the user fixes the mistake that was previously made in the process.

If, in step 222, the AP determines that the detected onboarding method is EZ mode, then, in step 224, the AP determines what band (i.e., 2.4 GHz, 5 GHz, or 6 GHz) the UE is currently using to communicate with the AP and, in step 226, the AP determines whether bandsteering to the 2.4 GHz band is needed. If not (i.e., if the UE is already in operating in the 2.4 GHz band), then the onboarding attempt using the EZ mode has not been successful, and processing proceeds to step 230 as before. Here, too, there are a few different scenarios where a user could make a mistake that could result in a failed attempt using the EZ mode onboarding method. One instance could be where the UE was too far away from the IoT device or the AP and the UE needs to be closer for a success. A subsequent attempt could result in a success if the user fixes the mistake that was previously made in the process.

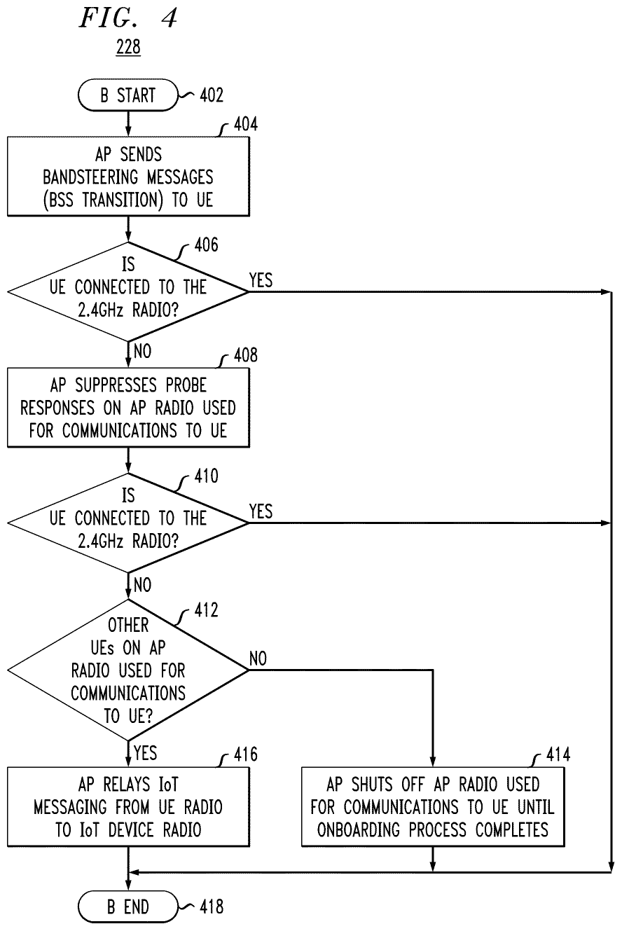

If, in step 226, the AP determines that bandsteering to the 2.4 GHz band is needed (i.e., if the UE is currently communicating in either the 5 GHz or 6 GHz band), then processing proceeds to step 228, where the AP performs the Steering Method processing of FIG. 4 to attempt to steer the UE to the 2.4 GHz band.

FIG. 4 is a flow diagram of the steps 402-418 involved in the AP performing the Steering Method processing of step 228 of FIG. 2 to attempt to steer the UE to the 2.4 GHz band. The processing of FIG. 4 starts at step 402 and proceeds to step 404, where the AP sends an instruction to the UE on the UE's current (i.e., 5 GHz or 6 GHz) band to transition to the 2.4 GHz band. Processing then proceeds to step 406, where the AP determines whether the UE is now operating in the 2.4 GHz band. If so, then the processing of FIG. 4 ends, in step 418, with the successful bandsteering of the UE to the 2.4 GHz band. Otherwise, processing proceeds to step 408.

In step 408, the AP stops responding to probes received from the UE on the UE's current (i.e., 5 GHz or 6 GHz) band to try to get the UE to switch to the 2.4 GHz band “on its own”. Those skill in the art will understand that a UE that fails to receive responses to its probes sent on the 5 GHz or 6 GHz band may switch to the 2.4 GHz band. If the AP determines, in step 410, that that attempt was successful (i.e., the AP is now receiving probes from the UE in the 2.4 GHz band), then here, too, the processing of FIG. 4 ends, in step 418, with the successful bandsteering of the UE to the 2.4 GHz band. Otherwise, the attempt of step 408 to get the UE to switch “on its own” to the 2.4 GHz band failed and processing proceeds to step 412.

In step 412, the AP determines whether there are any other wireless devices currently communicating with the AP in the same (i.e., 5 GHz or 6 GHz) band as the UE. If the AP determines, in step 412, that there are no other wireless devices operating in the UE's current band, then, in step 414, the AP stops all communications on the UE's current band again to try to get the UE to switch to the 2.4 GHz band “on its own”. That attempt of step 414 might or might not be successful (i.e., there is no guarantee that the Steering Method of FIG. 4, in particular, or, for that matter, the onboarding process of FIG. 2, in general, will be successful for every attempt). In any case, after step 414, the Steering Method of FIG. 4 ends at step 418.

If, however, the AP determines, in step 412, that there are other wireless devices operating in the UE's current band, then the AP should not stop all communications on the UE's current band (as in step 414) since doing so would disrupt the communications of those other wireless devices. Instead, in step 416, the AP translates incoming IoT messages received from the UE in the 5 GHz/6 GHz band into outgoing IoT messages in the 2.4 GHz band that will hopefully result in the IoT device connecting to the AP. In this case, the AP attempts to associate the IoT device with the AP using the EZ mode without bandsteering the UE to the 2.4 GHz band. Here, too, that attempt might or might not be successful. In any case, here, too, after step 416, the Steering Method of FIG. 4 ends at step 418.

Note that FIG. 4 shows one possible sequence of steps attempting to successfully associate the IoT device with the AP using the EZ onboarding mode. Those skilled in the art will understand that, in other implementations, the processing of FIG. 4 may involve steps in a different sequence and/or a suitable subset of those steps.

With the completion of the Steering Method of FIG. 4 (i.e., step BL of FIG. 2), the association of the IoT device with the AP will have either been successful or unsuccessful. In any case, following step 228, the processing of FIG. 2 continues to step 210 as before.

As described, if the AP-assisted onboarding processing of FIGS. 2-4 results in successful onboarding of the IoT device, then that processing will terminate. If, on the other hand, the AP-assisted onboarding processing of FIGS. 2-4 results in unsuccessful onboarding of the IoT device, then that processing will be repeated. In some implementations, the AP will set a limit to the number of times that the onboarding process can fail before the AP terminates the onboarding process and notifies the UE. In other implementations, the AP will not set such a limit and instead rely on the user of the UE to terminate (or re-new) the onboarding process.

The AP-assisted onboarding processing of FIGS. 2-4 can address a number of different situations that could otherwise result in unsuccessful onboarding of an IoT device including (without limitation) the following:
When the user fails to ensure that the UE is operating in the 2.4 GHz band for EZ mode onboarding;
When the IoT device is not in pair mode;
When the UE is on an unintended network;
When the IoT device connects to the correct WiFi network, but not to the application servers/cloud; and/or
When there is some other user error. In some implementations, the AP will notify the UE of the onboarding failure and provide some specific indication as to why the failure occurred.

For IoT devices that use AP mode onboarding, a function of the AP would be to monitor for successful or unsuccessful IoT device onboard and push user notifications to give the user visibility into the process.

Although embodiments have been described where an AP of a WiFi network assists in the onboarding of an IoT device using either AP or EZ mode onboarding, those skilled in the art will understand that the present disclosure can involve network-assisted onboarding of IoT devices onto suitable wireless networks other than WiFi networks and/or that may involve onboarding modes other than the AP and EZ modes.

In certain embodiments, the present disclosure is an access point (AP) for a wireless network, the AP comprising a memory and at least one processor, coupled to the memory and operative to assist in onboarding an IoT device onto the wireless network by the AP (i) determining an onboarding mode for the IoT device and (ii) based on the determined onboarding mode, assisting in onboarding the IoT device.

In at least some of the above embodiments, the AP is configured to determine whether the onboarding mode is an AP onboarding mode or an EZ onboarding mode.

In at least some of the above embodiments, the AP is configured to determine that the onboarding mode is the AP onboarding mode by detecting a beacon having a new SSID corresponding to an IoT provider.

In at least some of the above embodiments, the AP is configured to determine that the onboarding mode is the AP onboarding mode by determining that the beacon having the new SSID corresponding to the IoT provider has an SNR greater than a specified threshold.

In at least some of the above embodiments, the AP is configured to determine that the onboarding mode is the EZ onboarding mode by detecting multicast traffic from user equipment (UE) that contains IoT connection information.

In at least some of the above embodiments, the AP is configured to assist in the onboarding of the IoT device by determining whether the IoT device is associated with the AP. Upon determining that the IoT device is not associated with the AP, the AP is configured to determine whether the onboarding of the IoT device requires bandsteering. Upon determining that the onboarding of the IoT device does not require bandsteering, the AP is configured to instruct a UE to re-start onboarding the IoT device. Upon determining that the onboarding of the IoT device does require bandsteering, the AP is configured to attempt to steer the UE to a desired band. Upon determining that the IoT device is associated with the AP, the AP is configured to determine whether the IoT device has cloud connectivity. Upon determining that the IoT device has no cloud connectivity, the AP is configured to disassociate the IoT device from the wireless network and instruct the UE to re-start onboarding the IoT device.

In at least some of the above embodiments, upon determining that the onboarding of the IoT device requires bandsteering, the AP is configured to attempt to steer a UE from an undesired band to a desired band by instructing the UE to transition to the desired band.

In at least some of the above embodiments, upon determining that the onboarding of the IoT device requires bandsteering, the AP is configured to attempt to steer a UE from an undesired band to a desired band by suppressing responses to the UE in the undesired band.

In at least some of the above embodiments, upon determining that the onboarding of the IoT device requires bandsteering, the AP is configured to attempt to steer a UE from an undesired band to a desired band by shutting off all communications in the undesired band.

In at least some of the above embodiments, upon determining that a UE cannot be steered to a desired band, the AP is configured to relay IoT messages received from the UE in an undesired band as IoT messages from the AP in the desired band.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for an access point (AP) of a wireless network assisting in onboarding an Internet of Things (IoT) device onto the wireless network, the method comprising the AP:
determining an onboarding mode for the IoT device; and
based on the determined onboarding mode, assisting in onboarding the IoT device.

2. The method of claim 1, wherein the AP determines whether the onboarding mode is an AP onboarding mode or an EZ onboarding mode.

3. The method of claim 2, wherein the AP determines that the onboarding mode is the AP onboarding mode by detecting a beacon having a new SSID corresponding to an IoT provider.

4. The method of claim 3, wherein the AP determines that the onboarding mode is the AP onboarding mode by determining that the beacon having the new SSID corresponding to the IoT provider has a signal-to-noise ratio (SNR) greater than a specified threshold.

5. The method of claim 2, wherein the AP determines that the onboarding mode is the EZ onboarding mode by detecting multicast traffic from user equipment (UE) that contains IoT connection information.

6. The method of claim 1, wherein:
the AP assists in the onboarding of the IoT device by determining whether the IoT device is associated with the AP;
upon determining that the IoT device is not associated with the AP, the AP determines whether the onboarding of the IoT device requires bandsteering;
upon determining that the onboarding of the IoT device does not require bandsteering, the AP instructs a UE to re-start onboarding the IoT device;
upon determining that the onboarding of the IoT device does require bandsteering, the AP attempts to steer the UE to a desired band;
upon determining that the IoT device is associated with the AP, the AP determines whether the IoT device has cloud connectivity; and
upon determining that the IoT device has no cloud connectivity, the AP disassociates the IoT device from the wireless network and instructs the UE to re-start onboarding the IoT device.

7. The method of claim 1, wherein, upon determining that the onboarding of the IoT device requires bandsteering, the AP attempts to steer a UE from an undesired band to a desired band by instructing the UE to transition to the desired band.

8. The method of claim 1, wherein, upon determining that the onboarding of the IoT device requires bandsteering, the AP attempts to steer a UE from an undesired band to a desired band by suppressing responses to the UE in the undesired band.

9. The method of claim 1, wherein, upon determining that the onboarding of the IoT device requires bandsteering, the AP attempts to steer a UE from an undesired band to a desired band by shutting off all communications in the undesired band.

10. The method of claim 1, wherein, upon determining that a UE cannot be steered to a desired band, the AP relays IoT messages received from the UE in an undesired band as IoT messages from the AP in the desired band.

11. An access point (AP) for a wireless network, the AP comprising a memory and at least one processor, coupled to the memory and operative to assist in onboarding an IoT device onto the wireless network by the AP:
determining an onboarding mode for the IoT device; and
based on the determined onboarding mode, assisting in onboarding the IoT device.

12. The AP of claim 11, wherein the AP is configured to determine whether the onboarding mode is an AP onboarding mode or an EZ onboarding mode.

13. The AP of claim 12, wherein the AP is configured to determine that the onboarding mode is the AP onboarding mode by detecting a beacon having a new SSID corresponding to an IoT provider.

14. The AP of claim 13, wherein the AP is configured to determine that the onboarding mode is the AP onboarding mode by determining that the beacon having the new SSID corresponding to the IoT provider has an SNR greater than a specified threshold.

15. The AP of claim 12, wherein the AP is configured to determine that the onboarding mode is the EZ onboarding mode by detecting multicast traffic from user equipment (UE) that contains IoT connection information.

16. The AP of claim 11, wherein:
the AP is configured to assist in the onboarding of the IoT device by determining whether the IoT device is associated with the AP;
upon determining that the IoT device is not associated with the AP, the AP is configured to determine whether the onboarding of the IoT device requires bandsteering;
upon determining that the onboarding of the IoT device does not require bandsteering, the AP is configured to instruct a UE to re-start onboarding the IoT device;
upon determining that the onboarding of the IoT device does require bandsteering, the AP is configured to attempt to steer the UE to a desired band;
upon determining that the IoT device is associated with the AP, the AP is configured to determine whether the IoT device has cloud connectivity; and
upon determining that the IoT device has no cloud connectivity, the AP is configured to disassociate the IoT device from the wireless network and instruct the UE to re-start onboarding the IoT device.

17. The AP of claim 11, wherein, upon determining that the onboarding of the IoT device requires bandsteering, the AP is configured to attempt to steer a UE from an undesired band to a desired band by instructing the UE to transition to the desired band.

18. The AP of claim 11, wherein, upon determining that the onboarding of the IoT device requires bandsteering, the AP is configured to attempt to steer a UE from an undesired band to a desired band by suppressing responses to the UE in the undesired band.

19. The AP of claim 11, wherein, upon determining that the onboarding of the IoT device requires bandsteering, the AP is configured to attempt to steer a UE from an undesired band to a desired band by shutting off all communications in the undesired band.

20. The AP of claim 11, wherein, upon determining that a UE cannot be steered to a desired band, the AP is configured to relay IoT messages received from the UE in an undesired band as IoT messages from the AP in the desired band.
